(19) United States
(12) Patent Application Publication
(10) Pub. No.: US 2016/0301585 A1
(43) Pub. Date: Oct. 13, 2016

(54) REAL-TIME TRACKING AND VISIBILITY INTO APPLICATION COMMUNICATIONS AND COMPONENT INTERACTIONS

(71) Applicant: defend7, Inc., Mountain View, CA (US)

(72) Inventors: Vibhav Sreekanti, Pleasanton, CA (US); Gaurav Mathur, Palo Alto, CA (US); Richard Spillane, Mountain View, CA (US); Gordon Chaffee, Hillsborough, CA (US)

(21) Appl. No.: 15/097,449

(22) Filed: Apr. 13, 2016

Related U.S. Application Data
(60) Provisional application No. 62/146,556, filed on Apr. 13, 2015.

(51) Int. Cl. H04L 12/26; H04L 29/06

(52) U.S. Cl. CPC H04L 43/045; H04L 63/0823

(57) ABSTRACT

Systems, methods, and software provided herein generate a visual representation of communication between application components. In one example, a method of operating a method of operating a collection service system includes receiving a plurality of communication reports representing communications for application components, and storing the communication data from the plurality of communication reports in one or more data structures. The method further provides identifying administrator defined display parameters for the communication data, and generating a visual representation of the application components based on the display parameters and the one or more data structures.

### RELATED APPLICATIONS

This application is related to and claims priority to U.S. Provisional Patent Application No. 62/146,556, entitled “REAL-TIME TRACKING AND VISIBILITY INTO APPLICATION COMMUNICATIONS AND COMPONENT INTERACTIONS,” filed on Apr. 13, 2015, and which is hereby incorporated by reference in its entirety.

### TECHNICAL FIELD

Aspects of the disclosure are related to monitoring computing environments and in particular to generating visual representations of application component communications.

### TECHNICAL BACKGROUND

An increasing number of data security threats exist in the modern computerized society. These threats may include viruses or other malware that attack the local computer of the end user, or sophisticated cyber attacks to gather data and other information from the cloud or server based infrastructure. This cloud or server based infrastructure includes physical and virtual computing devices that are used to provide a variety of services to user computing systems, such as data storage, cloud processing, web sites and services, amongst other possible services. To protect applications and services, various antivirus, encryption, and firewall implementations may be used across an array of operating systems, such as Linux and Microsoft Windows.

In some examples, an organization may employ a plurality of application or service components, such as front-end components, back-end components, data storage management components, or any other similar component as part of an overarching application. These components may each operate as a physical computing system, or as virtual computing node alongside one or more other components on the same physical host. However, as more components are added to the system, it may become difficult for an administrator to identify the behavior of individual components as well as the various communications and interactions between different components, to determine anomalous change and security flaws within the environment.

### OVERVIEW

Provided herein are systems, methods, and software to generate visual representations of application component communications. In one example, a computer readable storage medium having instructions stored thereon that, when executed by a collection service system, direct the collection service system to perform a method of generating a visual representation of application component communications. The method includes receiving a plurality of communication reports representing communication data for communications by a plurality of application components, and storing the communication data from the plurality of communication reports in one or more data structures. The method further provides identifying administrator defined display parameters related to the plurality of application components, and generating a visual representation of the plurality of application components based on the display parameters and the one or more data structures.

In another examples, a collection service system to generate a visual representation of application component communications includes a communication interface configured to receive a plurality of communication reports representing communication data for communications by a plurality of application components. The collection service system further includes a processing system, communicatively coupled to the communication interface, and configured to store the communication data from the plurality of communication reports in one or more data structures. The processing system is further configured to identify administrator defined display parameters related to the plurality of application components, and generate a visual representation of the plurality of application components based on the display parameters and the one or more data structures.

In another instance, a method of operating a collection service system to generate a visual representation of application component communications includes receiving a plurality of communication reports representing communication data for communications by a plurality of application components, and storing the communication data from the plurality of communication reports in one or more data structures. The method further provides identifying administrator defined display parameters related to the plurality of application components, and generating a visual representation of the plurality of application components based on the display parameters and the one or more data structures.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing environment for reporting communication information to a collection service.

FIG. 2 illustrates a visibility process in a collection service to visually represent the communication interactions in a computing environment.

FIG. 3 illustrates a user interface to present a visual representation of a computing environment according to one example.

FIG. 4 illustrates an overview operation of a collection service system according to one example.

FIG. 5 illustrates an overview of transferring communication reports to a collection service according to one example.

FIG. 6 illustrates a communication report data structure according to one example.

FIG. 7 illustrates an overview of transferring communication reports from application components to a collection service.

FIG. 8 illustrates a user interface generated by a collection service.

FIG. 9 illustrates an overview of generating summary data structures for communication reports in a computing environment.

FIG. 10 illustrates a data structure for organizing relevant information in a computing environment according to one example.

FIG. 11 illustrates a user interface capable of illustrating application components as different service groups.

FIG. 12 illustrates a collection service system according to one example.

### TECHNICAL DISCLOSURE

Internet services rely extensively on security to prevent unpermitted processes and users from accessing sensitive data. Such data may include usernames, passwords, social security numbers, credit card numbers, amongst other sensitive data. To prevent the unpermitted access, firewalls, antiviruses, and other security processes may be executed on the devices hosting the computing services. These security processes are designed to prevent improper access, or mitigate the effects once a breach has occurred.

In some examples, multiple application components may be necessary to provide specific services to end user devices, such as front-end components, back-end components, data service components, administrative components, or any other component. Each of these components are responsible for a particular task, such as taking in and storing data, processing data that is received, organizing data received, or any other task necessary for the service. These application components may be implemented on one or more computing devices and processing systems configured by an administrator to perform the associated service.

In the present example, a plurality of application components may be deployed in a computing environment to provide processes required by an organization. These application components may each comprise a physical computing system, a Linux container, jail, partition, or other type of containment module, a full operating system virtual machine, or some other containment system, including combinations thereof. Here, in addition to the application components, a collection service may be provided, which is accessible to one or more administrators of the computing environment. This collection service communicates with agents associated with the application components to identify communication data for the components in the environment. This communication data may include the components involved in each communication, the type of communication format used for each communication, the type of security involved in each communication, the amount of data communicated in each communication, the timestamp for each communication, or some other type of communication information.

Once the communication information is identified, each of the agents communicates the information, as communication reports, to the collection service. In response to receiving the reports, the collection service stores the reports within one or more data structures, and provides analysis on the reports for the administrators of the computing environment. In some examples, the collection service may include one or more filters that are used to identify characteristics of each of the communications, such as whether the communication involved Hypertext Transfer Protocol (HTTP), Secure Sockets Layer (SSL), or some other communication format, and may further identify characteristics of the communication including the type of encryption used in the communication, the total amount of packets transferred, or some other communication information. For example, the collection service may be configured to filter or identify all communications that include sensitive information, such as credit card numbers or social security numbers. As a result, when the configured filter identifies a sensitive communication, the communication may be flagged as a sensitive communication or placed within a data structure with other sensitive communications. Once filtered by the collection service, the administrator may request a visual representation of the sensitive communications associated with the application components.

In some examples, the administrator may be provided with a user interface that provides the visual representation of the computing environment, and further lets the user select display parameters for the visual representation. These display parameters may include timing information, which allows the user to select a time period for relevant communication data, and may further include supplemental display parameters that allows the user to select specific traits within the communication data. For example, a user may select a time period of the last hour and request to view all SSL communications within the environment. Accordingly, any communication that qualifies based on the user selections may be displayed in the visual representation.

In some implementations, in addition to the communication data, the agents for each of the application components may further collect and transfer information about processing data for each of the application components. This processing data may include information about what processes are executing on the host, what packages are installed on the host, which of the applications are writing to disk, what types of data are being transferred between the application components, and other similar processing information for each of the application components. Once the information is gathered and transferred in the reports to the collection service, the collection service may store the information in one or more data structures, and present the processing data to an administrator.

In some examples, the processing data and the communication data may be presented to an administrator as a feed, or list that illustrates the current operations in the computing environment. For instance, a feed could be presented that provides “application X was updated at time Y,” along with other operations within the environment identified by the agents. In other instances, the processing data may be presented to the administrator as a visual representation of the computing environment, including visual representations of each of the components, the interconnections between the components, the processing data for each of the components, and any other similar information gathered from the agents within the environment.

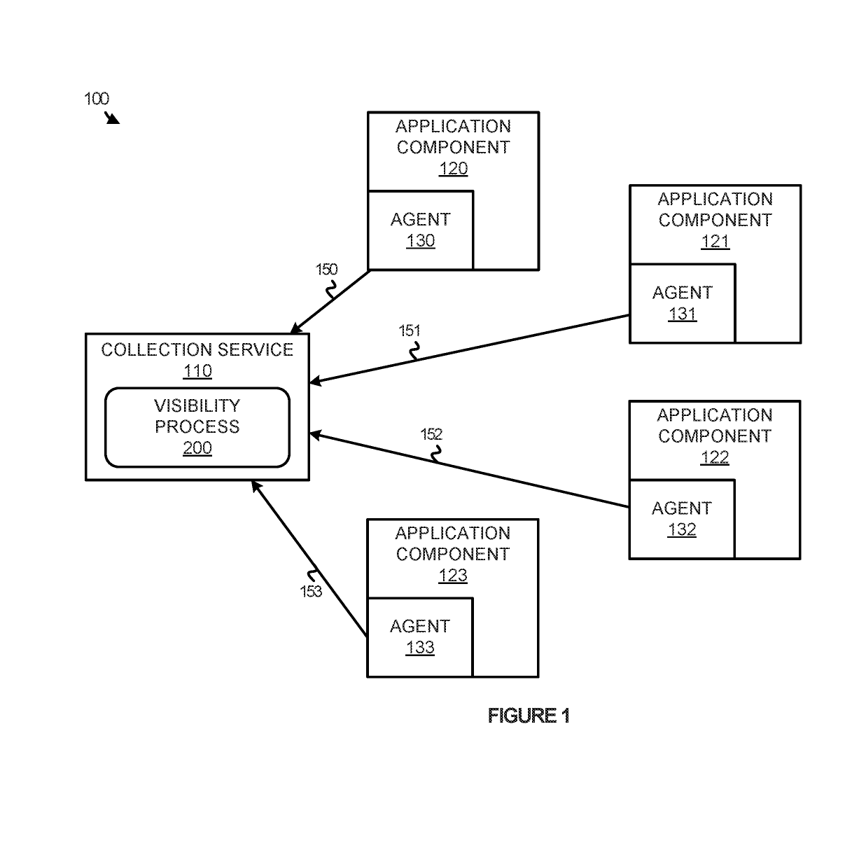

Referring now to FIG. 1, FIG. 1 illustrates a computing environment 100 for reporting communication information to a collection service. Computing environment 100 includes application components 120-123 and collection service 110. Application components 120-123 further include agents 130-133. Collection service 110 is configured to execute visibility process 200. Application components 120-123 communicate with collection service 110 via communication links 150-153.

Application components 120-123 may each comprise a Linux container, jail, partition, or other type of containment module, a full operating system virtual machine, or some other containment system, including combinations thereof. Application components 120-123 may execute via one or more host computing systems that may each include communication interfaces, network interfaces, processing systems, computer systems, microprocessors, storage systems, storage media, or some other processing devices or software systems, and can be distributed among multiple devices. In addition to or in place of the virtual components described above, in some examples, application components 120-123 may each comprise a physical computing system, such as a desktop or server computing system.

Collection service 110 may comprise a physical computing system, such as a desktop or serving computing system, and may also comprise a virtual node, such as a virtual machine or container, that executes via a host computing system. Collection service 110 may comprise communication interfaces, network interfaces, processing systems, computer systems, microprocessors, storage systems, storage media, or some other processing devices or software systems, and can be distributed among multiple devices.

Application components 120-123 communicate with collection service 110 via a plurality of communication links 150-153. These communication links may each use metal, glass, optical, air, space, or some other material as the transport media. Communication links 150-153 may use Time Division Multiplex (TDM), asynchronous transfer mode (ATM), IP, Ethernet, synchronous optical networking (SONET), hybrid fiber-coax (HFC), circuit-switched, communication signaling, wireless communications, or some other communication format, including improvements thereof. Communication links 150-153 may each be a direct link, or may include intermediate networks, systems, or devices, and may include a logical network link transported over multiple physical links.

In operation, each of application components 120-123 may communicate data with the various other application components, as well as external computing devices and systems. For example, a first application component, which is a front-end service, may provide data to a second application component, which is a back-end service. To manage the various connections made between the application components of computing environment 100, collection service 110 is provided to maintain the communication and transaction information for the plurality of application components 120-123. This communication information may include data flow information, such as the devices or application components involved in each communication, the type of data included in each communication, the type of communication format used in the connection, such as HTTP or SSL, the amount of data communicated, the type of security used in the communication, amongst a variety of other communication information.

In some examples, to retrieve the communication information, application components 120-123 may transfer communication reports in a predefined format to collection service 110. These communication reports may be transferred after each communication, may be transferred periodically, such as every fifteen minutes or some other periodic time frame, may be transferred upon request of collection service 110, or transferred during a downtime for the application component or for the host system. Once a report is transferred from one of agents associated with the application components, collection service 110 may organize the report into one or more data structures to assist in providing a visual representation of the computing environment to an end user or administrator. This visual representation may comprise a feed, list, or other similar text based visual representation for the administrator, or may comprise a graphical representation of each of the application components with the communication data overlaid thereon.

Although illustrated as located within the application components, it should be understood that agents 130-133 might reside on host computing systems providing the platform for application components 120-123. For example, if an application component comprises a virtual machine, the agent may operate within the kernel of the host system to determine the communication interactions for the application container. Thus, rather than having a single agent per application component, it should be understood that a single agent on a host computing system may manage the communication connections for a plurality of application components executing on the host.

In some implementations, in addition to the communication information gathered for each of the application components, data processing information may also be gathered by each of the agents and transferred in the reports to the collection service. This data processing information may include information about what processes are executing on the host, what packages are installed on the host, which of the applications are writing to disk, what types of data are being transferred between the application components, and other similar processing information for each of the application components. This data may be stored and presented to the user as a feed, or presented in a graphical representation of the network that includes the application components with the processing data and/or communication data overlaid thereon.

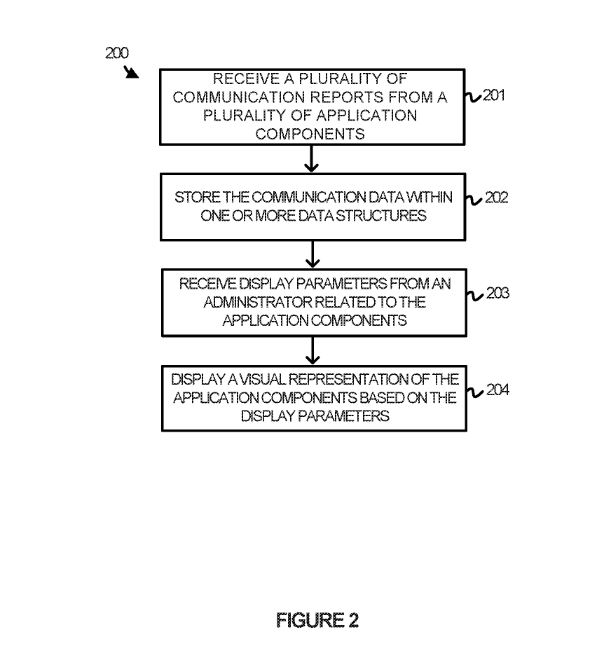

To further demonstrate the operation of collection service 110, FIG. 2 is provided. FIG. 2 illustrates a visibility process 200 to visually represent the communication interactions in computing environment 100. As described in FIG. 1, a computing environment may employ a plurality of application components, each configured to accomplish a particular task. For example, a first application component may comprise a front-end service, while a second application component may comprise a back-end service. Accordingly, to accomplish a desired functionality, the application components may require connections with one another, as well is with computing systems external to the computing environment. To maintain information about the various communications made by the application components, application components 120-123 include agents 130-133. Agents 130-133 identify information about the connections and communications made by the application components and provide the information to collection service 110. This information may include timestamp information for each communication, identifier information for the application components involved in each communication, data security information, such as SSL certificate information, for each communication, or content information, such as data packet total information or data sensitivity information, for each communication. Agents 130-133 may reside within the kernel of the computing system supporting application components 120-123, may reside as a process within application components 120-123, or may reside in any other location capable of identifying communication information and transferring the information as a communication report to collection service 110.

Visibility process 200 on collection service 110 includes receiving a plurality of communication reports representing communication data for communications by the plurality of application components 120-123 (201), and storing the communication data from the communication reports within one or more data structures (202). In some examples, storing the data within one or more data structures may comprise filtering the communication data in the communication reports using one or more communication filters. These filters may be able to identify communication data within the reports that relates to a particular communication characteristic. For example, the filters may be used to identify communications that relate to the netflow of data between the components within communication environment 100. Accordingly, if a communication occurred between an application component and a system external to environment 100, the filter may not identify this communication as part of the netflow for the environment, but would identify any communication between components 120-123. Once communication data is stored, visibility process 200 further receives or identifies display parameters related to application components 120-123 (203), and displays a visual representation of application components 120-123 based on the display parameters and the one or more data structures (204). In some instances, the display parameters related to the application components may include time period parameters to limit the display to communications to a defined time period, and may also include supplemental parameters corresponding to selective traits within the communication data. In some implementations, the visual representation of application components 120-123 may comprise a feed or other text based summary of the communication data. However, in other examples, the visual representation of application components 120-123 may comprise a graphical representation that includes application components 120-123 with collected data overlaid thereon as requested by the administrator.

For example, agent 130 in application component 120 may transfer a communication report to collection service 110. Collection service 110 will receive the report, and identify or filter the report into one or more data structures based on the communication data included in the report. Once stored in the one or more data structures along with other communication reports, an administrator or some other process in communication with collection service 110 may identify display parameters to generate a visual representation of the computing environment 100 including the communication information provided by agent 130. These display parameters, related to selective security traits in the communication data, may include viewing all netflow within computing environment 100, viewing all HTTP communications within the computing environment, viewing all SSL communications within the computing environment, or viewing any other similar traits related to the communications within the computing environment.

In some examples, to assist in the displaying the visual representation of computing environment 100, collection service 110 may be used to aggregate the communication data as it is received from agents 130-133. For example, the communication data from the reports may be aggregated into data structures based on a timestamp for when the communications occurred. Once aggregated, the combined data may be used to assist in generating the visual representation that is presented to the user. Accordingly, if the user selected a forty-five minute time period for which to display communication data about computing environment 100, collection service 110 may use the aggregated data structures to display the required information rather than compiling the report information at the time of the administrator selection.

In some instances, to aggregate the data, the communication reports received for application components 120-123 may be managed within special tree data structures to assist in the quick retrieval of necessary information for administrators. These tree data structures can be used to summarize particular information about the connections within the computing environment. For example, an administrator may desire to have access to the total number of packets transferred between two of the application components. Accordingly, nodes may be generated for the data tree corresponding to different time granularities for the total number of packets. Thus, a first node may be generated that comprises the longest period of time that communication data is available, and child nodes of the first node may represent subsections of time that, when summed together, generate the same value as the first node. For example, an hour node in the data tree may represent the total number of packets transferred for an hour time period, and four child nodes beneath the hour node may represent fifteen minute increments that, when summed together, generate the same value as the hour node. Once stored in the tree structure, any of the nodes may be used in generating a visual representation for an administrator, rather than compiling the report information at the time of the administrator's selection.

Although illustrated in the example of FIG. 1 as including four application components, it should be understood that any number of application components might be included within a communication environment. Further, although illustrated as located within each application component, it should be understood that in some examples agents 130-133 might be located within the kernel of their respective host computing systems. These agents may be installed on the computing systems when the machines are initiated, or may be dynamically added after the computing environment is operational.

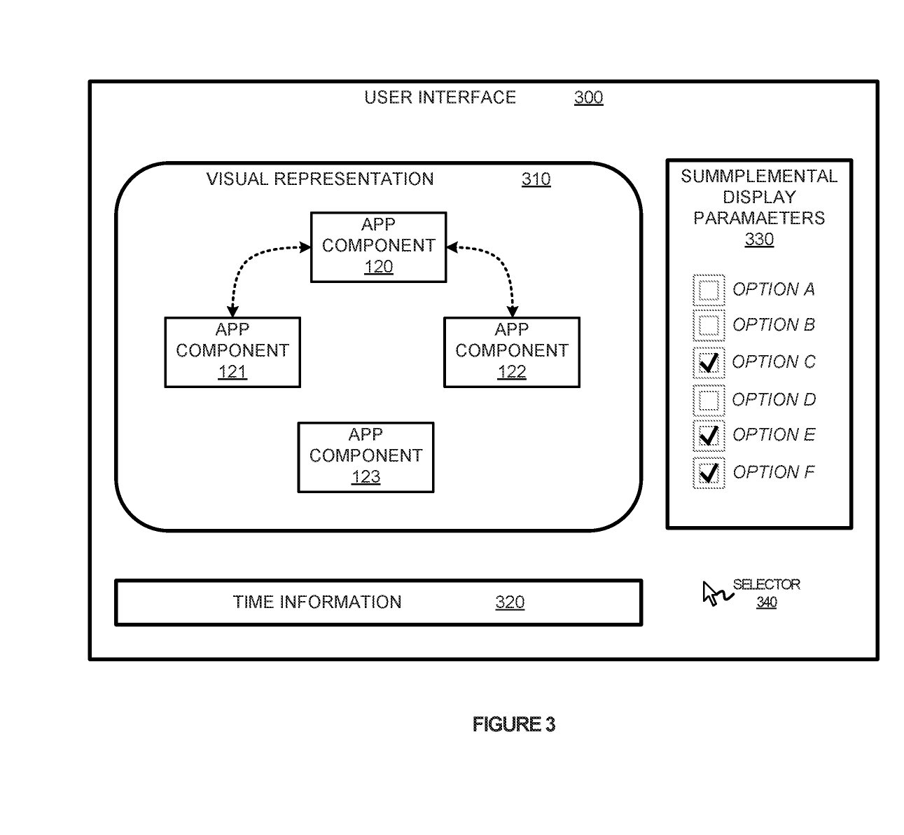

Turning to FIG. 3, FIG. 3 illustrates a user interface 300 to present a visual representation of computing environment 100. User interface 300 includes visual representation 310, time information 320, supplemental display parameters 330, and selector 340. User interface 300 is an example interface that may be generated by collection service 110 in FIG. 1, although other examples are possible. User interface 300 may be generated and displayed on the same computing system as collection service 110, or may be generated by collection service 110 and delivered to an end user device, such as a computer, mobile phone, tablet, or some other end user device.

As illustrated in the present example, visual representation 310 includes visual representations of application components 120-123. Further, user interface 300 allows a user or administrator to select time information 320, or a period of time for which communications and connections should be displayed. Time information 320 may comprise a time slider allowing the user to select the desired time period, a data entry box allowing the user to type or manually input the particular time period, or some other interface to define the desired time period. User interface 300 also allows a user to select particular supplemental display parameters 330 to filter or display particular traits of the communications between application components 120-123. Although illustrated with selector 340 in the present example to allow a user to select particular options within user interface 300, it should be understood that instead of a visual representation, such as a cursor, the user might use touch, voice, or some other interactive feature to select particular operations on user interface 300.

Here, the administrator selections within supplemental display parameters 330 include options C, E, and F, which are representative of various communication traits from the communication reports received for application components 120-123. These traits may include security attributes, such as encryption information, the type of communication format for a communication, the amount of data transferred between components, or any other similar communication traits. Accordingly, based on the parameter selections, interactions between the various application components that qualify for the selected traits may be displayed in visual representation 310.

In some examples, display parameters 330 may be used to identify possible security threats within a computing environment. For example, the options within supplemental display parameters 330 may be used to identify particular application components that are using a lower level of SSL security. Hence, based on the visual representation, the administrator may be able to identify the particular security vulnerabilities and address the vulnerabilities in future updates to the computing environment. These updates may include increasing the type of SSL security that is used between particular components, adding encryption to the communications between particular components, or any other similar update to the system. Thus, display parameters 330, in combination with the data structures for the communication data, may be used to define thresholds or criteria to flag particular issues within computing environment 100.

Although not illustrated in the present example, it should be understood that the visual interactions displayed in visual representation 310 may be color coded, assessed particular line patterns for the interactions, or given any other similar attributes to coordinate a particular parameter from display parameters 330 to the display on visual representation 310. For example, option C in display parameters 330 may be provided as a first color, whereas options E and F may be provided as second and third colors. This may assist the administrator in determining which connection corresponds to which attribute. In other examples, communications displayed in visual representation 310 must qualify for all of the selected supplemental display parameters 330. As a result, only communications that qualified for all of options C, E, and F may be displayed in visual representation 310.

Further, while not illustrated in the present example, it should be understood that the administrator might also desire to “zoom” or select particular portions of visual representation 310 to gather more information about the communications. For instance, the administrator may select the connector between application component 120 and application component 121 to gather more information about the one or more communications that occurred between the two components. This information may include the number of packets transferred between the components, the type of security that was used in the communication, the average packet length, the number of communications made, or any other similar information. Thus, by selecting the connectors, the administrator may be presented with a greater amount of detail about the particular interaction.

In some instances, to determine the appropriate display for visual representation 310, the collection service may parse or traverse the data structures for the appropriate data related to the user selection in time information 320 and display parameters 330. For example, if the administrator desired to identify all communications with a particular SSL key size, collection service may traverse the data structures and identify particular reports and communications associated with that request. In some instances, the collection service node may be configured to store one or more special data structures that assist in identifying particular attributes for a computing environment. These special data structures may comprise data trees, which allow communication data to be aggregated for variously sized time periods. For example, a data structure for the total packets transferred between two application components may include a first level that summarizes the total packets transferred during the operation of the computing environment, a second child level that summarizes the total packets transferred for hour increments during the operation of the computing environment, and a third level that summarizes the total packets transferred for fifteen minute increments during the operation of the computing environment. Thus, because the summaries are made prior to an administrator inquiry, a response may be generated for the administrator without having to compile all of the data for the necessary time period.

In some implementations, in addition to the communication data for each of the application components, agents may also report data processing information for each of the application components. This data processing information may include information about what processes are executing on the host, what packages are installed on the host, which of the applications are writing to disk, what types of data are being transferred between the application components, and other similar processing information for each of the application components. This data may be stored and presented to the user as a feed, or presented in a graphical representation similar to the representation in FIG. 3. For example, the user may select any of application components 120-123 to display data processing information about the component.

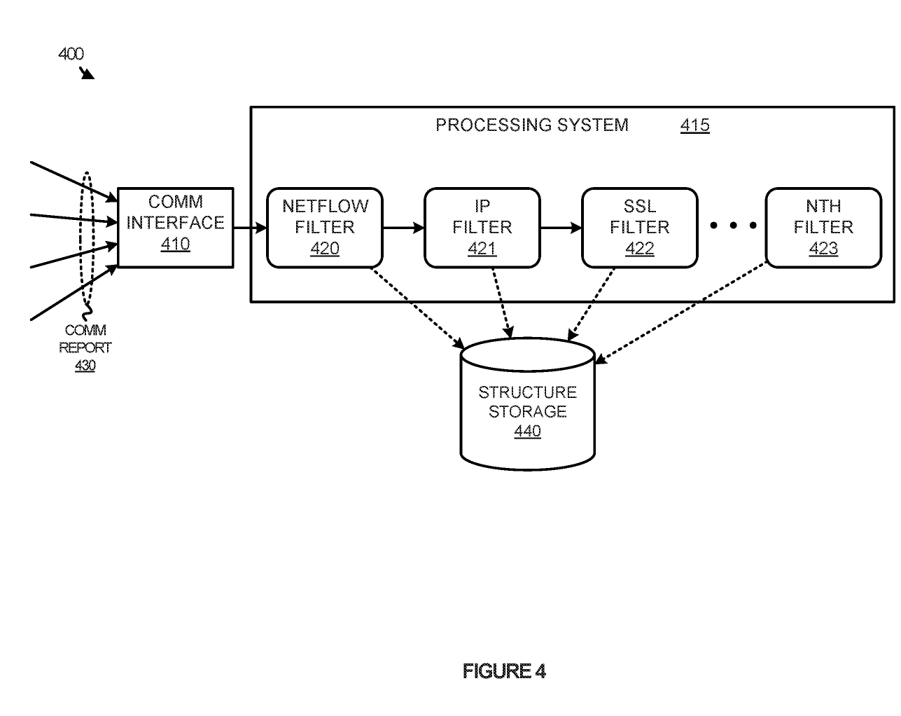

Turning to FIG. 4, FIG. 4 illustrates an overview operation of a collection service system 400 according to one example. Collection service system 400 includes communication interface 410, processing system 415, and structure storage 440. Processing system 415 is used to implement filters 420-423, which identify particular attributes for each communication and store the communication data in structure storage 440 based on the identified attributes. Although illustrated in the present example with four filters, it should be understood that any number of filters might be applied to the reports to identify relevant data.

As illustrated in the present example, a plurality of communication reports is received for collection service system 400 via communication interface 410. These communication reports originate from agents associated with application components, and include communication data such as the components or systems involved in a communication, the amount of data packets included in a communication, the type of security used in a communication, or any other similar communication information. Once the reports are received, the reports may be stored directly into structure storage 440, or filtered and organized to identify particular attributes in the received reports. Here, processing system 415 is used to execute a plurality of filters 420-423 to organize the data within structure storage 440.

In some examples, the filtering of the reports may be used to compile information for a particular communication trait. For example, netflow filter 420 might be configured to identify communications that occurred between two application components in the computing environment, IP filter 421 might be configured to identify communications that use HTTP, and SSL filter 422 might be configured to identify SSL communications and their various attributes, such as certificate information. Once a filter identifies a communication and report, the entire report may be placed in a data structure related to the filter, or a reference to the particular report may be saved in a data structure corresponding to the particular filter. Thus, when display of a parameter related to the filter is required, the data structure associated with the filter may be parsed to provide the necessary visual representation to the administrator.

Although illustrated as filtering the information as the reports are received, it should be understood that the reports might first be stored within structure storage 440 before being processed by filters 420-423. As a result, when the administrator or some other process defines particular communication traits that are relevant, the reports may be read in by processing system 415 for the appropriate filtering. For example, an administrator may desire information about the amount of data being communicated between two application components. As a result, processing system 415 may identify the communication reports associated with the two application components and filter the packet data totals from the reports to generate a summary data structure of the requested trait. Once the data structure is generated, collection service system 400 may query the data structure to display the total data transferred without parsing the reports at the time of the inquiry. Thus, the filters may be used to aggregate data into data structures to improve the response time to inquiries of the communication data.

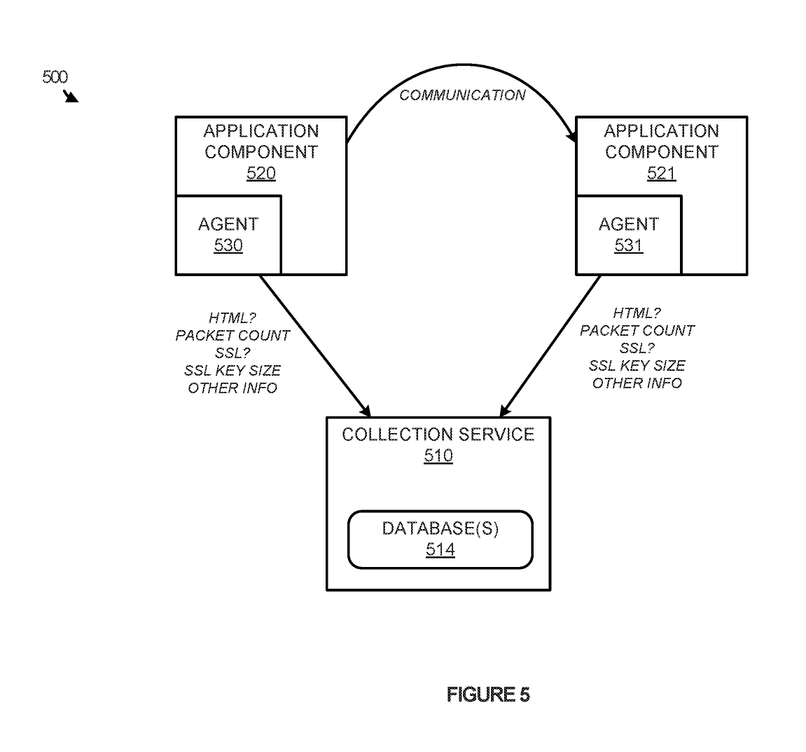

To further demonstrate the transfer of communication reports to a collection service, FIG. 5 is provided. FIG. 5 illustrates an overview of transferring communication reports to a collection service according to one example. Overview 500 includes collection service 510 and application components 520-521. Application components 520-521 are further associated with agents 530-531, which may operate within the application component or as part of the host executing the application component. Collection service 510 further includes databases 514 that are used to organize the reports and the communication data as they are received from a plurality of application components.

In operation, application components may communicate a variety of data between the components to provide a desired operation. For example, a backend application component may communicate with a database application component to gather necessary data for analysis. Here, agents 530-531 gather information about the communications between the components and transfer this information to collection service 510 as communication reports. The communication information may include information about the type of communication, such as HTTP, the number of packets transferred, the type of SSL security used in the communication, a timestamp associated with the communication, the type of data that was transferred, or any other similar information. The information may be transferred to collection service 510 periodically, upon request of collection service 510, or upon each communication between the application components.

Once the communication information is received by collection service 510, collection service 510 may store the report within one or more data structures based on the content of the reports. In at least one example, collection service 510 may maintain the reports in a first data structure based on the timestamps associated with the communications or reports, and may also maintain one or more other data structures based on the communication information included in the reports. For instance, a user may desire to monitor the type of SSL security used in the communications between application component 520 and application component 521. Accordingly, a data structure may be used that manages or summarizes the security used in the communications between the two components. In one example, the data structure may comprise a data tree that summarizes the SSL security for predefined periods of time. This data tree structure allows a first node to represent a first period time, with child nodes of the first node representing finer granularities of the first time period. As an example, a first node may represent an hour period for the communications, and four child nodes in the tree may represent fifteen-minute increments within that hour period.

Although illustrated in the present example as a communication between two components, it should be understood that collection service 510 might identify communication information for any number of application components. Further, collection service 510 and database(s) 514 may be used to process and store varying data structures for the application components to supply information to an end administrator.

In some implementations, agents 530-531 may also report information about the processes executing on application components 520-521. This information may include information about what processes are executing on the host, what packages are installed on the host, which of the applications are writing to disk, what types of data are being transferred between the application components, and other similar information for each of the application components. This data may be stored by collection service 510 and presented to the user as a feed, or presented in a graphical representation of the network that includes the application components with the processing data overlaid thereon. Similar to the filters described above with respect to the communication data, filters may also be applied to the processing information for the application components. For example, filters may be used to identify specific application packages stored on the disk, or application packages that are writing to disk. Once filtered, information may be provided to an administrator or user based on the filters.

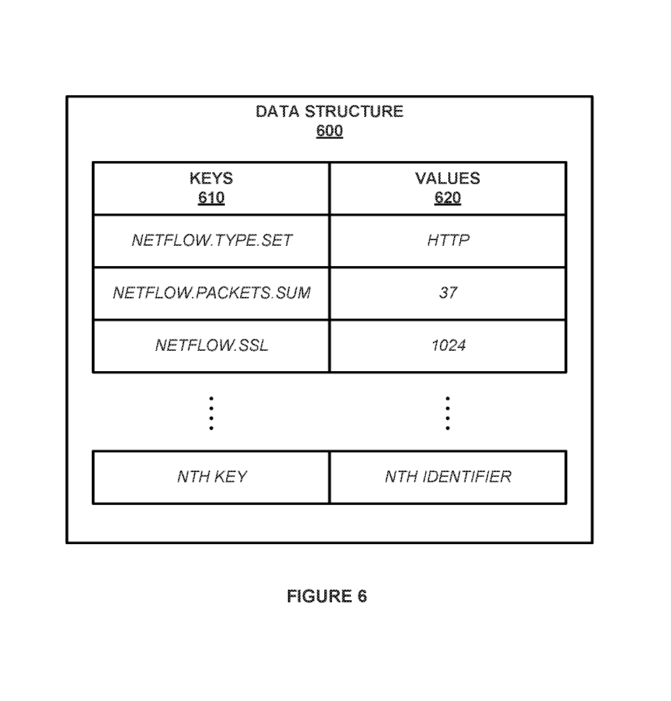

Referring now to FIG. 6, FIG. 6 illustrates a communication report data structure 600 according to one example. Data structure 600 includes keys 610 and values 620. As described herein, application components may have their communications tracked within a computing environment via communication agents. These application components may include front-end application components, database application components, back-end application components, or any other similar application component, including combinations thereof. As agents associated with the application components identify the communication information, the agents transfer the information as communication reports to a collection or management service that manages the communication information for the application components within the computing environment.

Here, data structure 600 is one example of a report that may be provided from the agent to the collection service. The information provided includes the type of communication made, the sum of the number of packets transferred, and the type of SSL security, but may include a variety of other information, such as whether the data transferred was sensitive, or any other information. Further, although not illustrated in the present example, it should be understood that the report might further identify the two application components that are communicating, the time at which the communication occurred, or any other similar information related to the communication.

Once the report is received from the agent, information within the report may be used to generate one or more data structures as described herein, and also provide a visual representation of the computing environment. Such a visual representation may assist an administrator in identifying the application components that are communicating, identifying the types of communications between the components, and identifying possible security flaws within the computing environment. In some examples, the reports may be filtered by the collection service to flag relevant data to be presented by the end user. To filter the communication data, a relevant key in keys 610 may be selected for the filter to identify the appropriate data. For example, if a filter was used to identify the total number of packets transferred, the filter may search each report for the NETFLOW.PACKETS.SUM key and determine the corresponding value from values 620. Once the value is identified, it may be added to the data structure that aggregates the information from the plurality of reports.

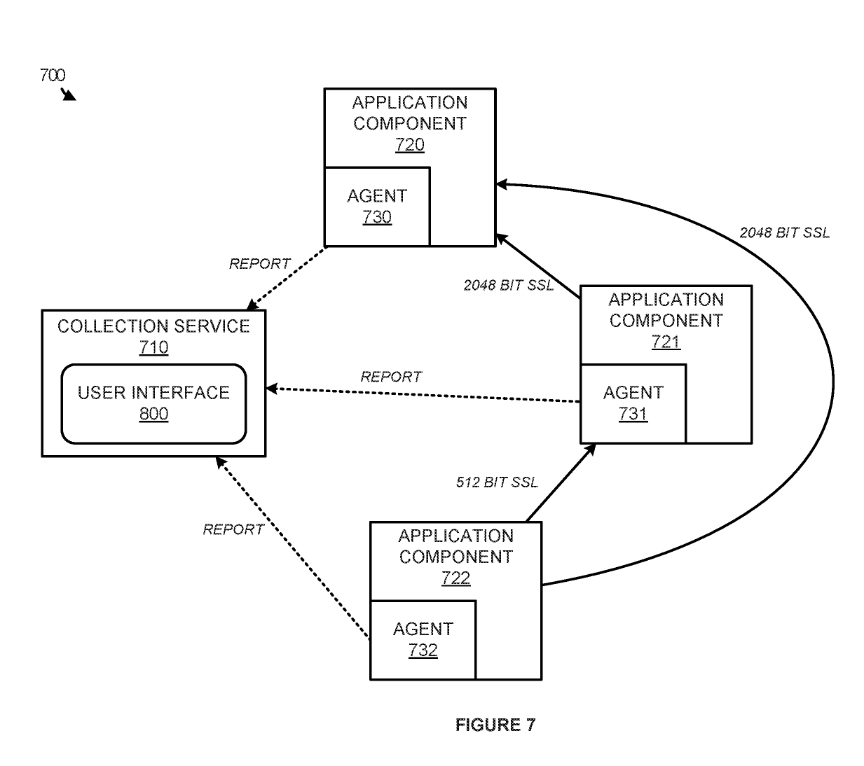

To further illustrate the operation of a collection service, FIG. 7 is provided. FIG. 7 illustrates an overview 700 of transferring communication reports from application components to a collection service. Overview 700 includes collection service 710 and application components 720-722. Application components 720-722 are associated with agents 730-732, which may reside inside the application component or on the host computing system, and provide reports to collection service 710. Collection service 710 is used to provide user interface 800 to a user or administrator based on the reports received from agents 730-732.

As illustrated in the present example, application components 721 and 722 communicate with application component 720 via 2048 bit SSL certificates. Further, application component 722 communicates with application component 721 via 512 bit SSL certificates. Based on these communications, agents 730-732 generate one or more reports and transfer the reports to collection service 710. Responsive to receiving the reports, collection service 710 places the reports into one or more data structures and performs analysis on the reports to assist in providing visual representations of the computing environment.

In some examples, collection service 710 may use one or more of the data structures to summarize particular aspects of the communications in the computing environment. For example, a summary data structure may be used to identify the communications with the lowest SSL security within the environment. Thus, if a criteria value were fixed, such as any communication at or below 512 bit SSL certificates, the summary data structure may include the communication from application component 722 to application component 721. Once a visual representation is required for the lowest SSL security, collection service 710 may query the data structure for the necessary information, rather than searching the individual reports at the time of the inquiry.

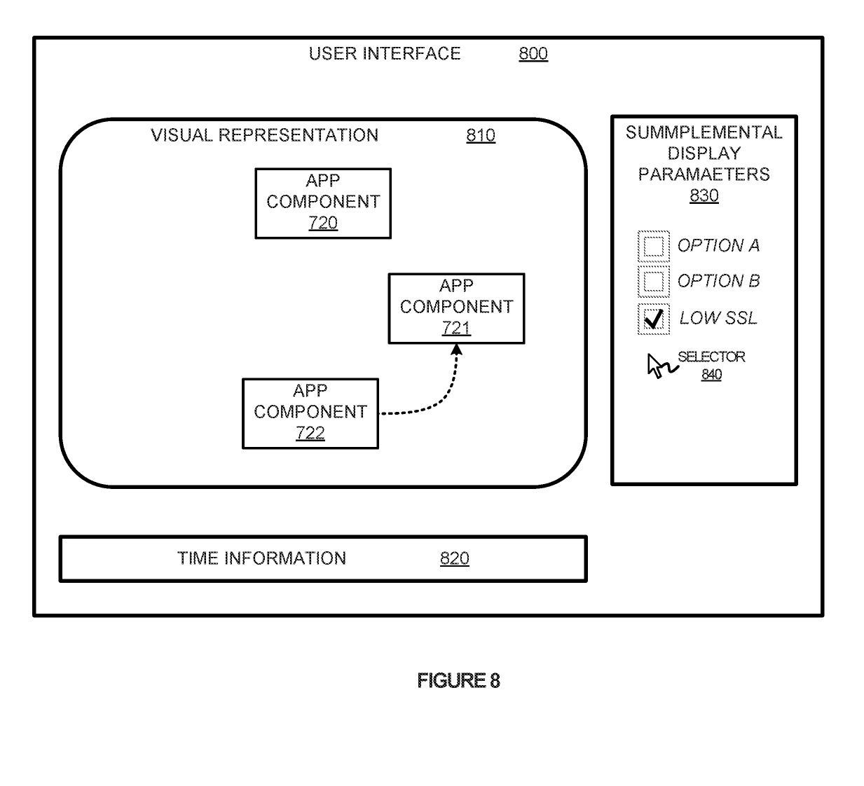

Referring now to FIG. 8, FIG. 8 illustrates user interface 800 generated by collection service 710. User interface 800 includes visual representation 810, time information 820, supplemental display parameters 830, and selector 840 to select the various options in user interface 800. Visual representation 810 further includes visual representations of application components 720-722. As depicted, an administrator has selected, via selector 840, “LOW SSL” to be defined within visual representation 810. Here, based on the reports generated from agents 730-732, the communication from application component 722 to application component 721 is identified as qualifying for the particular selection based on the predefined criteria.

As described above, once communication reports are received by collection service 710, the reports may be filtered and summarized for particular time periods. Thus, the report for the communication between component 722 and 721 may be flagged, while the other communications in overview 700 may not fulfill the SSL requirements. Once flagged and organized with a data structure associated with the “LOW SSL” parameter, the data structure may be used to generate visual representation 810 for the administrator. Accordingly, rather than identifying the communications that qualify for a particular parameter at the time of the query, a data structure may be pre-generated that allows collection service 710 to quickly identify the necessary elements to generate visual representation 810. In some examples, in addition to identifying “LOW SSL” in display parameters 830, the administrator may also identify a time period for visual representation 810. Consequently, rather than displaying all communications with a low SSL certificate, the user may select a particular time period from time information 820, and only the low SSL communications within that time period will be displayed.

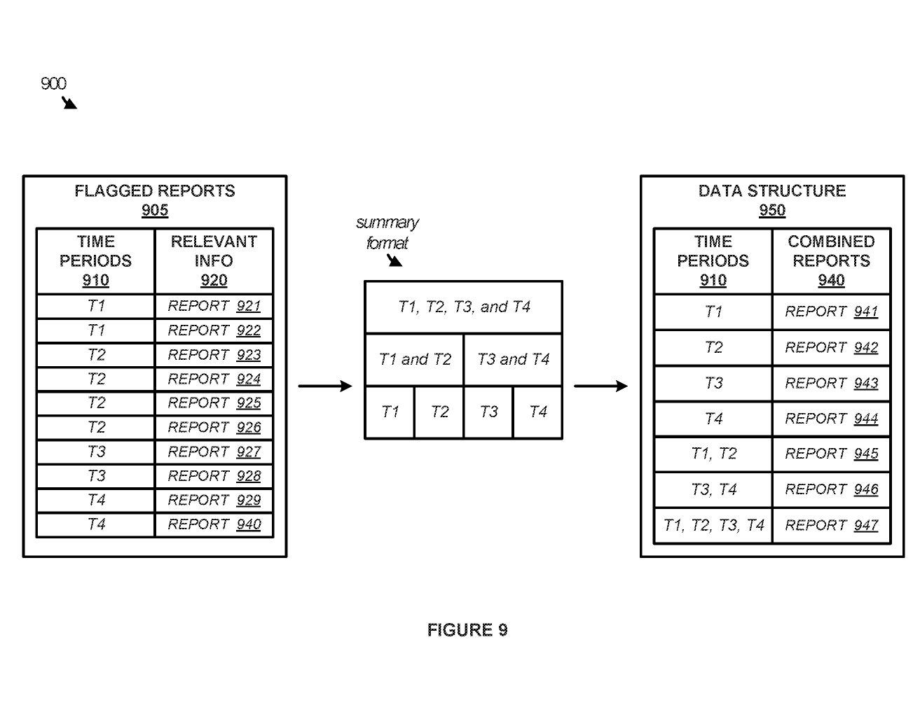

To further demonstrate the generation of data structures to summarize the communication reports, FIG. 9 is provided. FIG. 9 illustrates an overview 900 of generating summary data structures for communication reports in a computing environment. Overview 900 includes flagged reports 905 and data structure 950. As described herein, a collection service receives a plurality of communication reports from a plurality of agents corresponding to application components in a computing environment. As the communication reports are received, the collection service may filter the reports to identify relevant information requested by the administrator, or that has been predefined as important to the computing environment. This relevant information may include SSL characteristics for communications, information about which components are communicating during a particular time period, information about the sensitivity of the data, or any other similar data information.

Once the relevant information is identified within the reports, the information may be organized within data structures, such as data trees, based on the time that the reports were received. For example, a data tree may be generated that includes a first node that represents an hour of operation of the computing environment, and below the first node four child nodes may be included that represent the fifteen minute increments that comprise the hour. Accordingly, if an administrator wanted information about the hour period, rather than compiling the information from the communication reports at the time of the request, the appropriate node or nodes may be identified within the data structure and presented to the user.

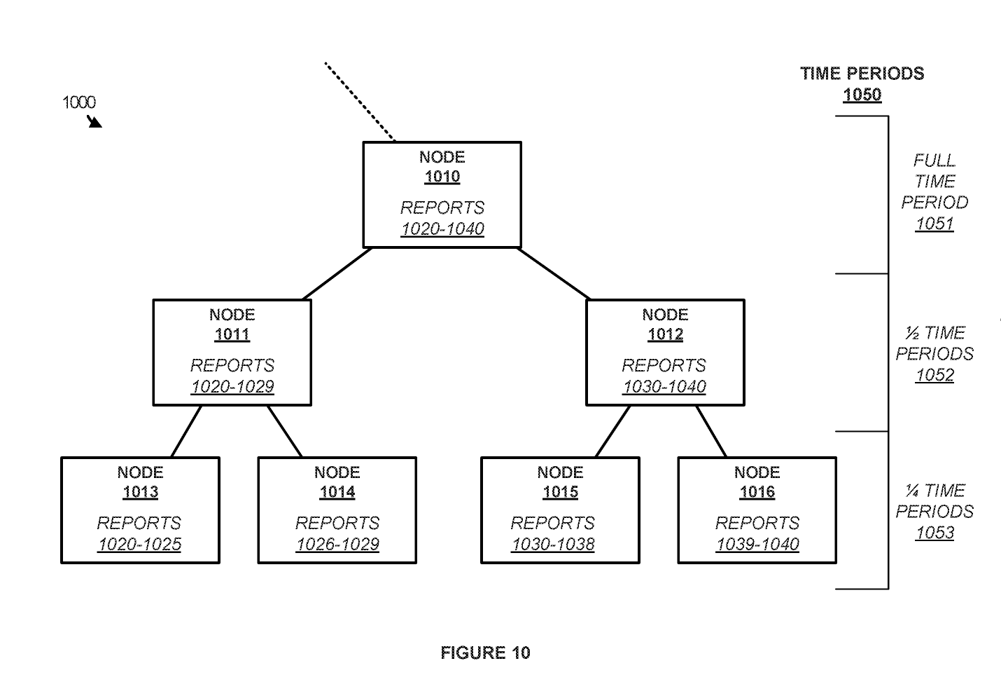

Here, flagged reports 905 includes time periods 910, which represent periods of time at which the communication occurred, and relevant information (info) 920, which represents a segment of information within the reports, such as SSL security, sensitivity of the data, or the total number of packets transferred in the communication. Once the reports are flagged, the reports may be summarized based on varying degrees of granularity. Thus, as an example, report 947 may be generated that includes all of the time periods, reports 945 and 946 may be generated that each include information from two of the time periods, and reports 941-944 may be generated as a summary of each individual time period. Although illustrated as a table in the present example that includes time periods 910 and combined reports 940, it should be understood that data structure 950 might comprise a tree data structure, such as that illustrated in FIG. 10. Once data structure 950 is generated and a request is received for information about time periods T3 and T4, data structure 950 may be searched and combined report 946 may be used to respond to the user inquiry.

Referring now to FIG. 10, FIG. 10 illustrates a data structure 1000 for organizing relevant information in a computing environment according to one example. Data structure 1000 includes nodes 1010-1016, reports 1020-1040, and time periods 1050. Time periods 1050 include full time period 1051, half time periods 1052, and quarter time periods 1053. In operation, a collection service receives a plurality of communication reports from a plurality of application components. Upon receipt of the communication reports, the collection service may filter or determine relevant characteristics of the reports for display or presentation to the end user. These relevant characteristics may be default characteristics that are pre-configured for the collection service or may be characteristics that are defined by the administrator for the particular computing environment.

As illustrated in FIG. 10, data structure 1000 is representative of a data tree to be used for a particular relevant communication characteristic from the computing environment. This characteristic or data item may include the total number of packets transferred between one or more application components, the type of SSL security transferred between one or more application components, the type of communication format, such as HTML, MySQL, or the like, or any other similar characteristic. Here, the identified relevant reports are organized into three different time periods for time periods 1050. These time periods include full time period 1051, half time period 1052, and quarter time period 1053. Full time period 1051 may be any period of time, such as an hour, a day, or any other similar time period, and time periods 1052-1053 may be the fraction thereof. Although not illustrated in the present example, it should be understood that node 1010 might be coupled to a parent node that represents a longer time period than node 1010.

As illustrated in data structure 1000, reports are placed into nodes based on the time period associated with their communication. Accordingly, communication report 1020, corresponding to a time at the beginning of full time period 1051, is placed in node 1013, node 1011, and node 1010, whereas communication report 1040, corresponding to a time at the end of full time period 1051, is placed in node 1016, node 1012, and node 1010. Once the relevant communication reports are identified and placed within the corresponding nodes, an administrator may use data structure 1000 to identify particular traits within the computing environment.

For example, an administrator may request a visual representation of the trait represented in data structure 1000 for the first three-quarters of full time period 1051. Accordingly, rather than searching each individual report to determine which reports qualify for the request, the collection service may combine the information from node 1011 and node 1015 to provide information about the first three-quarters of time period 1051. Once the nodes are added, a display may be presented to the administrator that includes information from reports 1020-1038. For example, if data structure 1000 were used to manage the total number of packets transferred between two application components, the packet totals for nodes 1011 and 1015 may be added to provide the packet total, which may be displayed to the user.

In some examples, the reports may include information that is duplicative with earlier reports. For example, data structure 1000 may be used to identify which application components are communicating with one another. As a result, if during the same time period two reports with the same communication path are identified, only one of the reports is necessary to be saved in the data structure as they illustrate the same interaction.

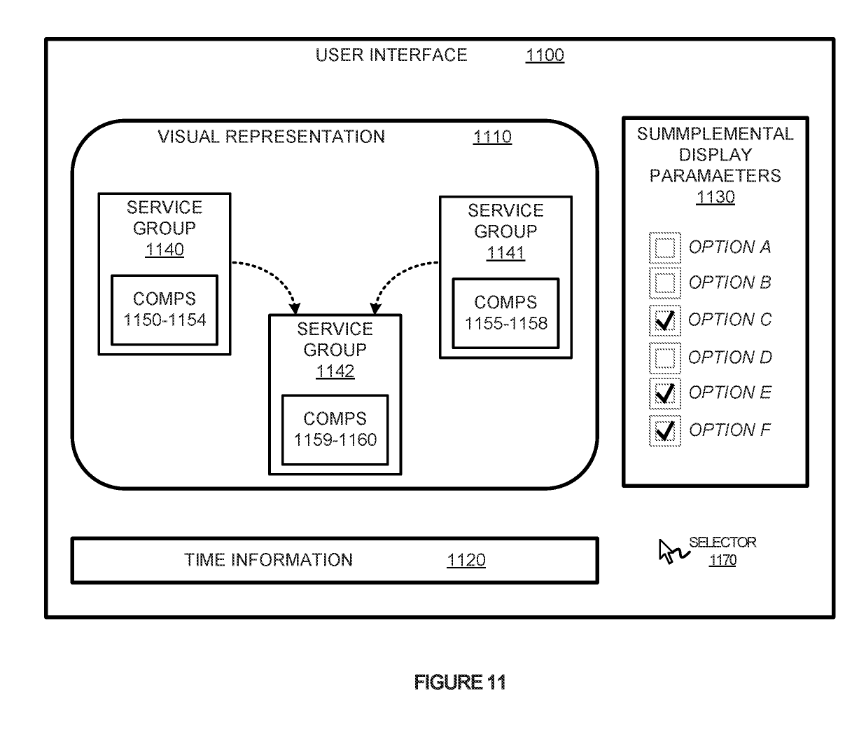

Referring now to FIG. 11, FIG. 11 illustrates a user interface 1100 capable of illustrating application components as different service groups. User interface 1100 includes visual representation 1110, time information 1120, supplemental display parameters 1130, and selector 1170 to select particular options on user interface 1100. Visual representation 1110 demonstrates the communication interconnections between multiple application components. In this example, visual representation 1110 includes service groups 1140-1142, which further comprise components 1150-1160.

As described herein, an application for an organization may employ a plurality of components such as front-end components, back-end components, database components, and other similar components. These components may execute as virtual machines, containers, physical machines, or some other similar component, including combinations thereof. In some examples, such as that illustrated in FIG. 11, similar components may be assembled into service groups 1140-1142. For instance, all components that comprise front-end components for the application or service may be grouped together into a single service group, whereas all components that comprise back-end components for the application or service may be grouped together in another service. By grouping the components together, an administrator may be able to view the interaction of the components at a different granularity than looking at the components directly. For example, an administrator may identify that the front-end service group is communicating with a back-end service group. Once identified, the user may further investigate these communications to identify the specific component making the communication, the type of communication being made, or any other characteristic about the communication between the two services.

In some examples, to select the display of the service groups, a display parameter may be included in supplemental display parameters 1130. As a result, when the user or administrator selects to group one or more of the components, the components may be displayed based on the service that they provide, such as front-end service, back-end service, and the like. Further user interface 1100 may allow the user to “zoom” or separate particular service groups to identify further details about the connections made by the components within the group. For example, a user may select to zoom in on service group 1420 to determine which of components 1159-1160 are communicating with service group 1140, and which components 1159-1160 are communicating with service group 1141.

As illustrated in FIG. 11, user interface 1100 further includes time information 1120. This portion of the user interface may allow an administrator to view the various connections for a particular period of time. Once a period of time is selected, visual representation 1110 may reflect the connections made during the time period desired by the end user. Further, the time information 1120 may be used in conjunction with supplemental display parameters 1130 to allow an administrator to view particular traits of the computing environment over the selected time period.

In some implementations, in addition to the communication information for each of the components, information may be gathered about the processes executing on each of the application components. In particular, this process information may include data about the packages installed on each of the components, the time that the packages were installed, the packages that are writing to disk for the application components, when the packages write to disk, or any other similar information about the processes on the individual components. Once the process information is received as reports from the agents associated with the components, the information may be stored in one or more data structures and displayed for an administrator of the environment with the communication information. In some implementations, the process information may be provided to the administrator in a graphical representation similar to the representation of FIG. 11, wherein the individual components are grouped as a service. From this graphical representation the user may select a service and/or a particular component and be provided with the process information for the service and/or component. In other examples, rather than providing a graphical representation of the computing environment, the administrator may be provided with a feed or list of processing information events that are occurring in the environment. The administrator may then filter this feed for a particular time, component, information type, or some other filter, including combinations thereof.

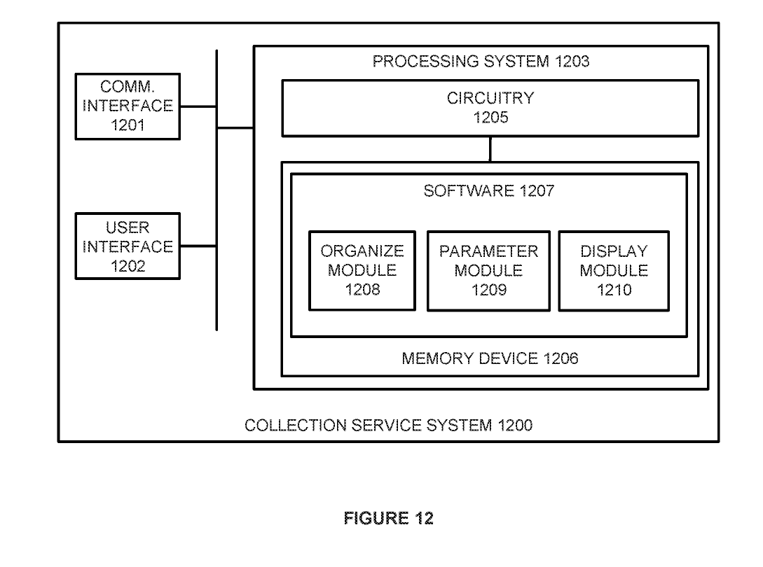

Referring to FIG. 12, FIG. 12 illustrates a collection service system 1200 that is representative of any computing system or systems with which the various operational architectures, processes, scenarios, and sequences disclosed herein for a collection service node may be implemented. Collection service system 1200 is an example of collection service nodes 110, 510, and 710, although other examples may exist. Collection service system 1200 comprises communication interface 1201, user interface 1202, and processing system 1203. Processing system 1203 is linked to communication interface 1201 and user interface 1202. Processing system 1203 includes processing circuitry 1205 and memory device 1206 that stores operating software 1207. Collection service system 1200 may include other well-known components such as a battery and enclosure that are not shown for clarity. Collection service system 1200 may be a personal computer, server, or some other computing apparatus—including combinations thereof.

Communication interface 1201 comprises components that communicate over communication links, such as network cards, ports, RF transceivers, processing circuitry and software, or some other communication devices. Communication interface 1201 may be configured to communicate over metallic, wireless, or optical links. Communication interface 1201 may be configured to use Time Division Multiplex (TDM), Internet Protocol (IP), Ethernet, optical networking, wireless protocols, communication signaling, or some other communication format—including combinations thereof. Specifically, communication interface 1201 may communicate with one or more other computing systems to gather communication reports for a plurality of application components.

User interface 1202 comprises components that interact with a user to receive user inputs and to present media and/or information. User interface 1202 may include a speaker, microphone, buttons, lights, display screen, touch screen, touch pad, scroll wheel, communication port, or some other user input/output apparatus—including combinations thereof. In some instances, user interface 1202 may be used to receive user input regarding display parameters related to the communication data gathered for the plurality of application components. User interface 1202 may be omitted in some examples.

Processing circuitry 1205 comprises microprocessor and other circuitry that retrieves and executes operating software 1207 from memory device 1206. Memory device 1206 comprises a non-transitory storage medium, such as a disk drive, flash drive, data storage circuitry, or some other memory apparatus. Processing circuitry 1205 is typically mounted on a circuit board that may also hold memory device 1206 and portions of communication interface 1201 and user interface 1202. Operating software 1207 comprises computer programs, firmware, or some other form of machine-readable processing instructions. Operating software 1207 includes organize module 1208, parameter module 1209, and display module 1210, although any number of software modules may provide the same operation. Operating software 1207 may further include an operating system, utilities, drivers, network interfaces, applications, or some other type of software. When executed by processing circuitry 1205, operating software 1207 directs processing system 1203 to operate collection service system 1200 as described herein.

In particular, operating software 1207 directs processing system 1203 to receive a plurality of communication reports representing communication data for communications by a plurality of application components. In some examples, to receive the communication reports, communication interface 1201 may communicate with one or more agents associated with the plurality of application components. These agents, either residing in the component or in the host executing the component, identify communication data for the application components, and provide the communication data as communication reports to collection service system 1200. Once the reports are received, organize module 1208 directs processing system 1203 to store the communication data from the communication reports into one or more data structures. In some examples, the communication data includes a time stamp for each communication by the application components. Thus, based on the time stamp for each of the communications, organize module 1208 may place the communication data within the one or more data structures.

As communication data is stored via organize module 1208, parameter module 1209 directs processing system 1203 to identify administrator defined display parameters related to the plurality of application components and the communication data. For example, a user may specify a desire to view all communications by the application components below a predefined threshold SSL certificate bit level. Further, the user may also provide a desired time period for which to view the SSL information, such as the last fifteen minutes, hour, or any other time period for which communication reports have been gathered. In some instances the display parameters may be gathered by collection service system 1200 via user interface 1202. However, in other examples, communication interface 1201 may be communicatively coupled to one or more console devices that allow an administrator to specify the desired parameters remotely.

Once the display parameters are received, display module 1210 directs processing system 1203 to generate a visual representation of the plurality of application components based on the display parameters and the one or more data structures. For example, if the user desired to view all communications by the application components in the last half hour, the data structures may be used to identify the necessary communication data and generate a visual representation of the communications within the last half hour.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A computer readable storage medium having instructions stored thereon that, when executed by a collection service system, direct the collection service system to perform a method of generating a visual representation of application component communications, the method comprising:
receiving a plurality of communication reports representing communication data for communications by a plurality of application components;
storing the communication data from the plurality of communication reports in one or more data structures;
identifying administrator defined display parameters related to the plurality of application components; and
generating a visual representation of the plurality of application components based on the display parameters and the one or more data structures.

2. The computer readable storage medium of claim 1, wherein the plurality of application components comprises at least one front-end component and at least one back-end component.

3. The computer readable storage medium of claim 1, wherein the communication data for each communication comprises application component identifiers for application components involved in each communication, data security information for each communication, and content information for each communication.

4. The computer readable storage medium of claim 3, wherein the data security information comprises at least Secure Sockets Layer (SSL) certificate information, and wherein the content information comprises at least data packet total information and data sensitivity information.

5. The computer readable storage medium of claim 1, wherein the plurality of application components comprise Linux containers, full operating system virtual machines, and/or physical computing systems.

6. The computer readable storage medium of claim 1, wherein the administrator defined display parameters comprise time period parameters and supplemental parameters corresponding to selective security traits within the communication data for the communications.

7. The computer readable storage medium of claim 1, wherein storing the communication data from the plurality of communication reports in the one or more data structures comprises storing the communication data from the plurality of communication reports in the one or more data structures based on a timestamp for each communication represented in the communication data.

8. The computer readable storage medium of claim 1, wherein receiving the plurality of communication reports representing the communication data for the plurality of application components comprises receiving, from one or more agents associated with the plurality of application components, the plurality of communication reports representing the communication data for the plurality of application components.

9. A collection service system to generate a visual representation of application component communications, the collection service system comprising:
a communication interface configured to receive a plurality of communication reports representing communication data for communications by a plurality of application components; and
a processing system, communicatively coupled to the communication interface, configured to:
store the communication data from the plurality of communication reports in one or more data structures;
identify administrator defined display parameters related to the plurality of application components; and
generate a visual representation of the plurality of application components based on the display parameters and the one or more data structures.

10. The collection service system of claim 9, wherein the plurality of application components comprises at least one front-end component and at least one back-end component.

11. The collection service system of claim 9, wherein the communication data for each communication comprises application component identifiers for application components involved in each communication, data security information for each communication, and content information for each communication.

12. The collection service system of claim 11, wherein the data security information comprises Secure Sockets Layer (SSL) certificate information, and wherein the content information comprises data packet total information and data sensitivity information.

13. The collection service system of claim 9, wherein the plurality of application components comprise Linux containers, full operating system virtual machines, and/or physical computing systems.

14. The collection service system of claim 9, wherein the administrator defined display parameters comprise time period parameters and supplemental parameters corresponding to selective security traits within the communication data for the communications.

15. The collection service system of claim 9, wherein storing the communication data from the plurality of communication reports in the one or more data structures comprises storing the communication data from the plurality of communication reports in the one or more data structures based on a time stamp for each communication represented in the communication data.

16. A method of operating a collection service system to generate a visual representation of application component communications, the method comprising:
receiving a plurality of communication reports representing communication data for communications by a plurality of application components;
storing the communication data from the plurality of communication reports in one or more data structures;
identifying administrator defined display parameters related to the plurality of application components; and
generating a visual representation of the plurality of application components based on the display parameters and the one or more data structures.

17. The method of claim 16, wherein the plurality of application components comprise Linux containers, full operating system virtual machines, and/or physical computing systems.

18. The method of claim 16, wherein the communication data for each communication of the communications comprises application component identifiers for application components involved in each communication, data security information for each communication, and content information for each communication.

19. The method of claim 18, wherein the data security information comprises at least Secure Sockets Layer (SSL) certificate information, and wherein the content information comprises at least data packet total information and data sensitivity information.

20. The method of claim 16, wherein generating the visual representation of the plurality of application components based on the display parameters and the one or more data structures comprises generating a display of a subset of the communications for the plurality of application components based on the display parameters and the one or more data structures.
